(19) United States
(12) Patent Application Publication
(10) Pub. No.: US 2025/0083051 A1
(43) Pub. Date: Mar. 13, 2025

(54) Game Scene Recommendation With AI-Driven Modification

(71) Applicant: Sony Interactive Entertainment LLC, San Mateo, CA (US)

(72) Inventor: Angela Webb, San Mateo, CA (US)

(21) Appl. No.: 18/463,704

(22) Filed: Sep. 8, 2023

(51) Int. Cl. A63F 13/67; A63F 13/533; A63F 13/79

(52) U.S. Cl. CPC A63F 13/67; A63F 13/533; A63F 13/79

(57) ABSTRACT

A computer-implemented method for recommending video game gameplay to a user is provided, including: receiving a social media feed of the user; analyzing the social media feed to determine a sentiment of the user; using the sentiment of the user to identify a scene of a video game; presenting a recommendation of the identified scene to the user through a user interface of a gaming platform, the recommendation configured to enable initiation of gameplay of the identified scene.

### BACKGROUND OF THE INVENTION

The video game industry has seen many changes over the years. As technology advances, video games continue to achieve greater immersion through sophisticated graphics, realistic sounds, engaging soundtracks, haptics, etc. Players are able to enjoy immersive gaming experiences in which they participate and engage in virtual environments, and new ways of interaction are sought. Furthermore, players may stream video of their gameplay for spectating by spectators, enabling others to share in the gameplay experience.

It is in this context that implementations of the disclosure arise.

### SUMMARY OF THE INVENTION

Implementations of the present disclosure include methods, systems and devices for recommending gameplay of a scene of a video game to a user of a gaming platform.

In some implementations, a computer-implemented method for recommending video game gameplay to a user is provided, including: receiving a social media feed of the user; analyzing the social media feed to determine a sentiment of the user; using the sentiment of the user to identify a scene of a video game; presenting a recommendation of the identified scene to the user through a user interface of a gaming platform, the recommendation configured to enable initiation of gameplay of the identified scene.

In some implementations, analyzing the social media feed includes analyzing content of posts or reactions by the user occurring in the social media feed.

In some implementations, determining the sentiment of the user includes identifying topics, genres, or styles of interest based on the social media feed.

In some implementations, determining the sentiment of the user includes identifying an emotional state of the user based on the social media feed.

In some implementations, the method further includes: determining an initial game state for the identified scene of the video game, wherein the initial game state is applied to the identified scene of the video game when gameplay of the identified scene is initiated through the user interface.

In some implementations, determining the initial game state includes retrieving user save data associated with the user from a prior gameplay of the video game by the user.

In some implementations, determining the initial game state is based on the determined sentiment of the user.

In some implementations, the method further includes: identifying an asset used in the identified scene of the video game; modifying the identified asset based on the determined sentiment of the user.

In some implementations, modifying the asset includes using a generative artificial intelligence (AI) to modify an appearance of the asset.

In some implementations, modifying the asset includes generating a prompt for the generative AI based on the determined sentiment of the user.

In some implementations, a non-transitory computer-readable medium is provided having program instructions embodied thereon that, when executed by at least one computer, cause said at least one computer to perform a method for recommending video game gameplay to a user, said method including: receiving a social media feed of the user; analyzing the social media feed to determine a sentiment of the user; using the sentiment of the user to identify a scene of a video game; presenting a recommendation of the identified scene to the user through a user interface of a gaming platform, the recommendation configured to enable initiation of gameplay of the identified scene.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a system for recommending a scene of a video game for gameplay to a user, in accordance with implementations of the disclosure.

FIG. 2 conceptually illustrates various scenes of various video games which may be recommended for gameplay, in accordance with implementations of the disclosure.

FIG. 3 conceptually illustrates asset modification or creation in accordance with implementations of the disclosure.

FIG. 4 conceptually illustrates a system for generating a custom game for a user, in accordance with implementations of the disclosure.

FIG. 5 conceptually illustrates a user interface for recommending a game scene to a user, in accordance with implementations of the disclosure.

FIG. 6 illustrates components of an example device 600 that can be used to perform aspects of the various embodiments of the present disclosure.

### DETAILED DESCRIPTION OF THE INVENTION

Broadly speaking, implementations of the present disclosure provide systems and methods for recommending a scene of a video game for gameplay by a user. For example, a social media feed of the user can be analyzed to determine the sentiment of the user, including the user's emotional state, interests, activities, etc. This information can be used to select a scene of a video game that is recommended to the user for gameplay. In some implementations, the video game can be specifically a video game from the user's library of video games, and initiating gameplay can be configured to use the user's saved data from their previous gameplay of the video game. In other implementations, the game state setup can be determined based on the user's sentiment. The recommendation of the video game scene can be presented through a gaming platform user interface. In some implementations, assets for the recommended video game scene can be modified based on the user's sentiment using a generative AI.

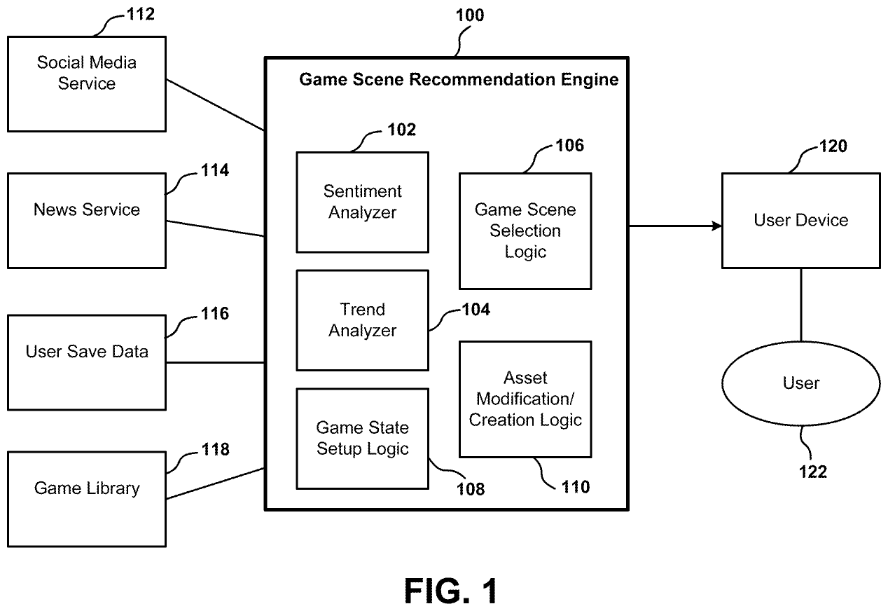

FIG. 1 conceptually illustrates a system for recommending a scene of a video game for gameplay to a user, in accordance with implementations of the disclosure.

Broadly speaking, a game scene recommendation engine 110 is implemented and configured to recommend a scene of gameplay to a user 122. In some implementations, the game scene recommendation engine 110 is implemented as part of a network accessible gaming service platform (not shown) that provides services for enabling video games to be accessed and played by the user 122. Examples of such services include providing user account services, providing a game store for purchasing and downloading game titles, providing cloud storage of user save data from gameplay, providing social features (e.g. chat, messaging, social graph), providing spectating of others' gameplay, etc. One example of a gaming service platform is the PlayStation® Network.

The game scene recommendation engine 100 includes a sentiment analyzer 102 that is configured to determine the sentiment of the user 122 by analyzing data from a social media service 112. For example, the user 122 may link their social media account to the gaming service platform to provide access to their social media feed and activity on the social media service 112. For example, the sentiment analyzer 102 may examine contents of the user's social media feed and social media activity such as posts by the user 122, posts by friends of the user 122, posts by users or entities that are followed by the user 122, comments, text, emojis, reactions (e.g. likes, thumbs up/down, expressions, etc.). The sentiment analyzer 102 analyzes such content and/or other data from the social media service 112 to determine the sentiment of the user. The determined sentiment of the user can include the user's emotional state (e.g. happy, sad, energetic, tired, angry, peaceful, etc.) and current interests (e.g. topics of interest, genres of interest, styles of interest, etc.). In some implementations, the sentiment analyzer 102 employs a sentiment analysis technique to analyze the content and data from the social media service 112. In some implementations, the sentiment analyzer 102 uses natural language processing, a machine learning model, or other technique to determine the user sentiment.

The game scene recommendation engine 100 further includes a game scene selection logic 106 that is configured to select a particular game scene of a video game based on the determined sentiment of the user 122. Broadly speaking, in some implementations, the game scene selection logic 106 maps various kinds of user sentiment to various game scenes of various video games, so that a particular game scene can be selected based on the user's particular determined sentiment. In this manner, a particular game scene is selected that is suitable for the user's particular determined sentiment.

In some implementations, a game scene is selected that matches the user's determined sentiment, such as by matching the emotional state of the user or matching determined interests of the user. For example, if the user is feeling energetic, then an energetic game scene may be selected so as to match the user's mood. Or if the user has expressed an interest in a new horror movie, then a game scene from a video game in the horror genre may be selected so as to match the user's interest. Furthermore, if the new horror movie is specifically a zombie horror movie, then a game scene may be selected that includes zombies in the gameplay.

In some implementations, a game scene is selected so as to be therapeutic or otherwise appropriate for the user's sentiment. For example, if the user is feeling angry, then a game scene may be selected that is configured to be peaceful or calming. Of if the user is feeling sad, then a game scene may be selected that is configured to be joyful or humorous or uplifting.

In some implementations, the game scene is selected so as to be related to contents of the user's social media feed. For example, the user's social media feed may include posts about a friend's pet dog, and accordingly, the game scene selection logic 106 may select a game scene involving dogs or other pets such as cats.

In some implementations, the game scene selection logic 106 employs a model (e.g. a machine learning model) configured to map various kinds of user sentiment to game scenes of video games. In some implementations, features of game scenes are identified and the various kinds of user sentiment are mapped to these features.

In some implementations, game scene recommendation engine 100 further includes a trend analyzer 104 configured to identify trending topics or items which can be additionally used by the game scene selection logic 106 to select a particular game scene for recommendation to the user 122. In some implementations, the trend analyzer 104 analyzes information from a news service 114 to determine the trending topics or items. In some implementations, the news service 114 provides a news feed, which can be a news feed associated with a user account of the user 122 on the news service 114, and may therefore be tailored to the user's interests. As noted, the trending items from the news can be used to influence selection of a particular game scene by the game scene selection logic 106. For example, a trending news item may relate to a particular geographical location in the world, and accordingly, a game scene may be selected that is set in or depicts that geographical location, or is defined in a setting that resembles or has characteristics similar to that geographical location (e.g. similar topography, architecture, language, dress, etc.).

As another example, a trending topic may involve a particular object or event, and accordingly, a game scene may be selected that includes a similar object or event. For example, a trending topic may relate to a sporting event, and accordingly, a game scene may be selected involving the same sport, and perhaps the same teams as the real-life sporting event. Or a trending topic may relate to a concert by a particular musical artist, and accordingly, a game scene may be selected featuring a soundtrack or song by that musical artist. Or a trending topic may relate to an object such as a submarine, and accordingly, a game scene may be selected involving a submarine.

It will be appreciated that in some implementations, the user 122 is not able to play a given video game unless they own the video game and it is in the user's game library 118. Accordingly, in some implementations, the game scene selection logic 106 is configured to select a game scene from a video game that is specifically in the user's game library 118. However, in other implementations, the game scene selection logic 106 may select a game scene from a video game that is not owned by the user. In some implementations, if the game scene is selected from a game that is in the user's game library, then the user is able to continue gameplay of the video game even after completion of the selected game scene. Whereas if the game scene is selected from a game that is not in the user's game library, then the user is not able to continue gameplay of the video game after completion of the selected game scene.

In some implementations, the game scene recommendation engine further includes game state setup logic 108, which is configured to setup or define the initial game state for the selected game scene when gameplay is initiated. In some implementations, the user may have previously played the video game, and their saved game data is available as part of user save data 116. For example, their saved game data may include data saved at various points in the video game that can be used to configure a session of the video game to enable the user to resume gameplay from the various points with the same game state. In some implementations, user save data 116 can include saved game data corresponding to the selected game scene of the video game, and this saved game data is retrieved by the game state setup logic 108 to define the initial game state for the selected game scene when gameplay is initiated. It will be appreciated that by incorporating the user's own saved game data, then the user may already be familiar with the state of the game scene when initiating gameplay, and so be more likely to enjoy success during gameplay.

In some implementations, the game state setup logic 108 is configured to modify or otherwise define the initial game state based on the determined user sentiment and/or trending items. For example, in some implementations, a specific virtual item or character can be selected for inclusion in the game scene based on the user sentiment or trends. For example, if there is an identified item of interest based on the user sentiment or an item that is trending in the news, then a similar virtual item may be selected for inclusion in the game scene and so defined as part of the initial game state. Or if a particular style is identified, then virtual items that are in that style may be selected for inclusion.

The concept can be extended to other configurable aspects of the game scene. For example, in a game scene in which the weather is configurable, then the weather may be chosen based on the user sentiment or trends. Or if the background is configurable, then the background may be chosen based on the user sentiment or trends. In some implementations, the game state setup logic 108 uses a model (e.g. a machine learning model) to configure the initial game state for the game scene.

The game scene recommendation engine 100 further includes an asset modification/creation logic 110, which is configured to modify or create an asset for the selected game scene based on the user sentiment or trends. For example, if the user sentiment or trend information identifies a particular style, then the asset modification/creation logic 110 may modify or create a given asset for the selected game scene so as to have the particular style. More specific implementations of the asset modification/creation logic 110 are discussed in further detail below.

It will be appreciated that the selected game scene is recommended to the user for gameplay. In some implementations, the recommended game scene is surfaced through a user interface of the gaming service platform presented by a user device 120. For example, the user device 120 can be a game console, personal computer, laptop, tablet, mobile device, portable gaming device, set-top box, streaming device, or any other device capable of rendering a user interface including the game scene recommendation, and facilitating gameplay of the recommended game scene if initiated by the user. In some implementations, initiation of the game scene entails local execution of the video game by the user device 120, e.g. with gameplay video being rendered to a display (e.g. television, monitor, projector, head-mounted display (HMD), etc., which can be separate from or integrated with the user device 120). Whereas in a cloud gaming implementation, initiation of the game scene entails execution of the video game by a cloud game machine, with the gameplay video being streamed to the user device 120 over the Internet for presentation on a display.

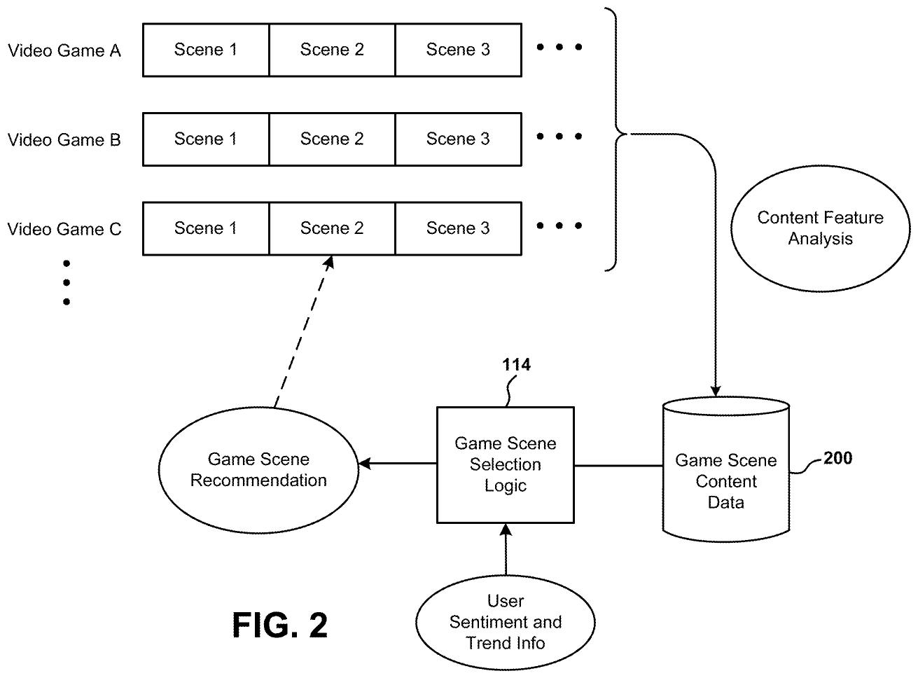

FIG. 2 conceptually illustrates various scenes of various video games which may be recommended for gameplay, in accordance with implementations of the disclosure.

As shown in the illustrated implementation, a Video Game A includes various scenes including a Scene 1, Scene 2, and Scene 3. Likewise, a Video Game B and Video Game C also include various scenes as shown. In some implementations, a scene of a video game can be any discreet portion of the video game's campaign, such as a segment, chapter, level, stage, or portion thereof. In some implementations, a scene can be defined by a particular virtual location within the broader virtual environment of the video game. In some implementations, a scene can be defined by a particular objective to be achieved or completed or performed, such as a boss fight, a mission, etc. In some implementations, a scene can be defined by a match or contest between particular entities such as characters or teams (e.g. sports match between two teams).

In some implementations, a content features analysis process is performed on the various scenes of the video games to determine features of the various game scenes. These features are configured to describe the contents of the game scenes and characterize aspects which may be useful for enabling selection of the game scenes based on user sentiment and trends. The determined features are stored as game scene content data 200, and used by the game scene selection logic 114 to select a given game scene for recommendation in accordance with implementations of the disclosure.

By way of example without limitation, features of game scenes can include data describing objects/characters or assets within a game scene, activity occurring within a game scene, a location of a game scene, an art style or mood of the game scene, audio in the game scene, etc. In some implementations, the game scene selection logic 114 uses the user sentiment and trend information to identify corresponding features of the game scene content data 200 and select a given game scene having the corresponding features for recommendation.

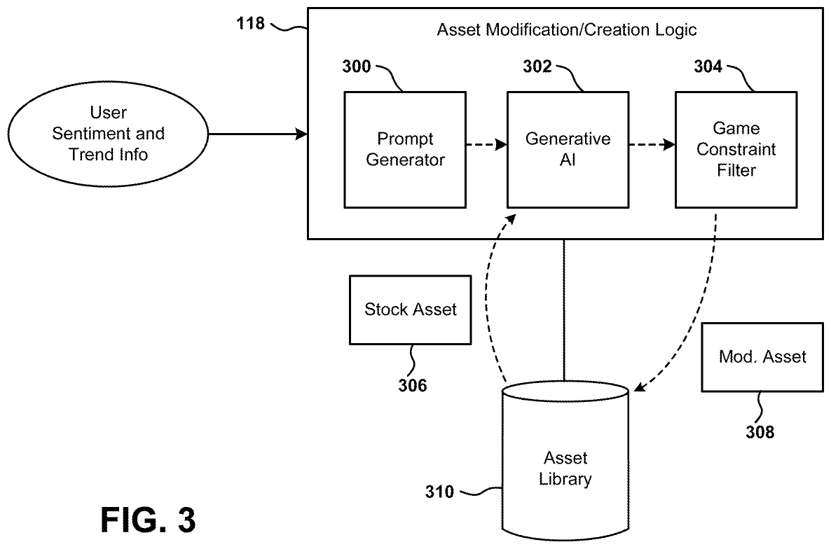

FIG. 3 conceptually illustrates asset modification or creation in accordance with implementations of the disclosure.

As noted, an asset modification/creation logic 118 is configured to modify or create an asset based on the user sentiment and trend information for the recommended game scene. In some implementations, the asset modification/creation logic 118 implements a generative artificial intelligence (AI) 302 to enable the asset modification or creation. In some implementations, the generative AI 302 is configured to receive a stock asset 306 from an asset library of the video game (whose game scene has been selected), and generate modifications based on the user sentiment and trend information. In some implementations, a prompt generator 300 is configured to generate a prompt for the generative AI 302 based on the user sentiment and trend information. For example, the prompt may specify characteristics that are to be incorporated in the modifications to be generated by the generative AI 302.

In some implementations, the generated modifications may then be subject to a game constraint filter 304 that is configured to evaluate the generated modifications to ensure that they are suitable for the video game. For example, the game constraint filter 304 may evaluate the generated modifications to ensure that the modified asset is still consistent with or capable of functionality that the asset is expected to perform in the video game. If the generated modifications are not suitable, then the game constraint filter 304 may provide feedback to the generative AI 302 to regenerate the modifications, with input configured to correct the aspects which were not suitable. When the modifications are deemed to be suitable for the video game, then the modified asset 308 is stored to the asset library 310. In some implementations, the modified asset is used in place of the stock asset for purposes of the recommended game scene.

It will be appreciated that in some implementations, the stock asset 306 is an asset of the video game that has not been modified by the user. Whereas in other implementations, the stock asset 306 may be an asset of the video game that has been modified by the user, possibly through the user's gameplay using the asset. For example, a character/avatar may change during the user's gameplay of the video game, and this character/avatar may be modified as presently described for the game scene. In this manner, the user may recognize their character/avatar in the game scene, but with modifications based on their sentiment and trend information. For example, the user sentiment may indicate the user is celebrating a particular holiday, and the user's avatar/character might be modified so as to wear clothing that is indicative of that holiday.

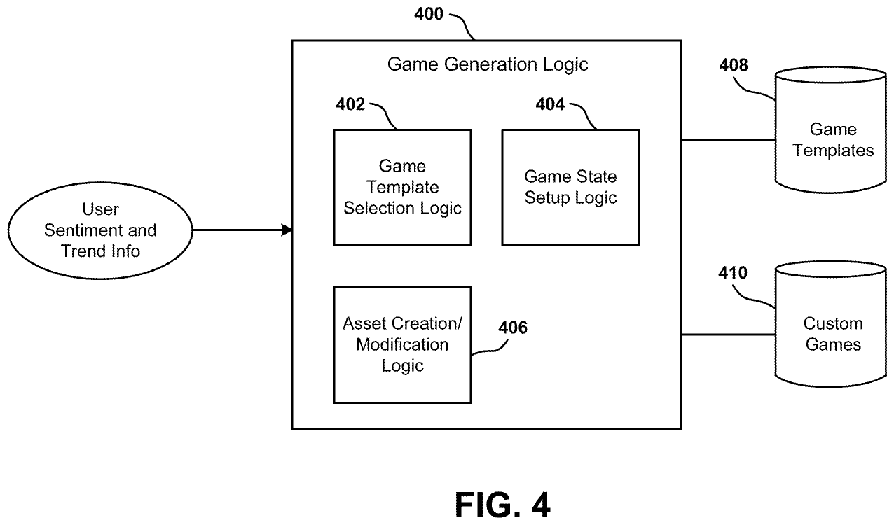

FIG. 4 conceptually illustrates a system for generating a custom game for a user, in accordance with implementations of the disclosure.

In a related concept to the game scene recommendation described herein, in some implementations, a custom game can be generated and recommended to a user based on their determined sentiment and trend information. In the illustrated implementation, game generation logic 400 is implemented, for example by a gaming service platform as described, and configured to generate a custom game for the user based on the user's sentiment and trend information.

A game template selection logic 402 is configured to select a game template from a plurality of game templates 408, based on the user sentiment and trend information. The game templates define various kinds of video games which can be further customized to the user. And accordingly, a particular game template is selected that matches or is otherwise suitable or in accordance with the user sentiment and trend information. For example, if the user sentiment indicates an interest in cars, then the game template selection logic 402 might select an automotive racing game template from the game templates 408.

A game state setup logic 404 is implemented to define an initial game state to be applied to the selected game template to define the custom game, based on the user sentiment and trend information. For example, customizable aspects of the initial game state may be determined by the game state setup logic 404, such as which items or assets to incorporate into the custom game, values of settings, etc.

An asset creation/modification logic 406 is implemented to modify or create assets for the custom game. In some implementations, the asset creation/modification logic 406 can operate similar to that described above with respect to the recommended game scene.

The custom game can be stored to a custom games storage 410. In some implementations, the custom game can be recommended to the user through a user interface of the gaming service platform.

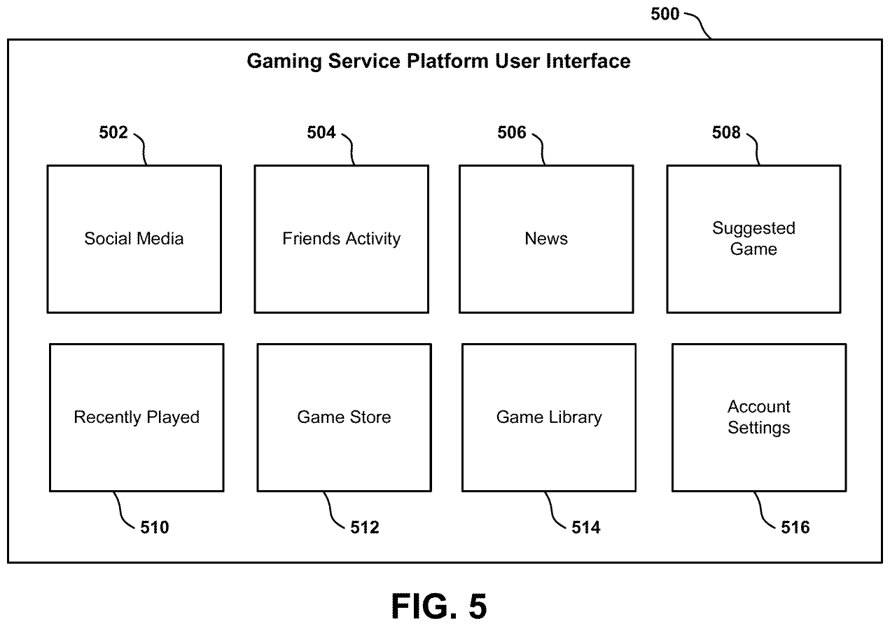

FIG. 5 conceptually illustrates a user interface for recommending a game scene to a user, in accordance with implementations of the disclosure.

In the illustrated implementation a gaming service platform user interface 500 is shown, through which the user may access game-related services. The gaming service platform user interface 500 can be rendered by the user's device (e.g. game console, computer, etc.) on a display, as previously described.

In the illustrated example, the user interface 500 includes a number of tiles or icons providing access to different services. For example, a recently played tile 510 can be selected to enable the user to resume their gameplay of a recently played video game. A game store tile 512 is selectable to access a game store whereby the user can purchase and/or download video games to play. A game library tile 514 is selectable to access the user's library of game titles. And an account settings tile 516 provides access to various settings related to the user's account on the gaming service platform.

Furthermore, in some implementations, the user interface 500 can include a social media tile 502 that provides access to the user's social media feed from a social media service. In some implementations, the social media tile 502 is itself configured to display at least some of the social media feed. In some implementations, the gaming service platform enables users to connect with each other as friends, forming a social graph, and a friends' activity tile 504 provides access to the user's friends' activity on the gaming service platform, such as their gaming activity, achievements, messages, etc. In some implementations, the friends' activity tile 504 is itself configured to display at least some of the user's friends' activity on the gaming service platform.

In some implementations, the user interface 500 includes a news tile 506 that provides access to news information, which can be in the form of a news feed from a news service. In some implementations, the news tile 506 can itself be configured to display at least some of the new information, such as headlines or subtitles. And in some implementations, the user interface 500 includes a suggested game tile 508, which can provide access to a recommended game scene or custom game, in accordance with implementations of the disclosure as described herein. In some implementations, the suggested game tile 508 is configured to display a preview of the recommended game scene or custom game.

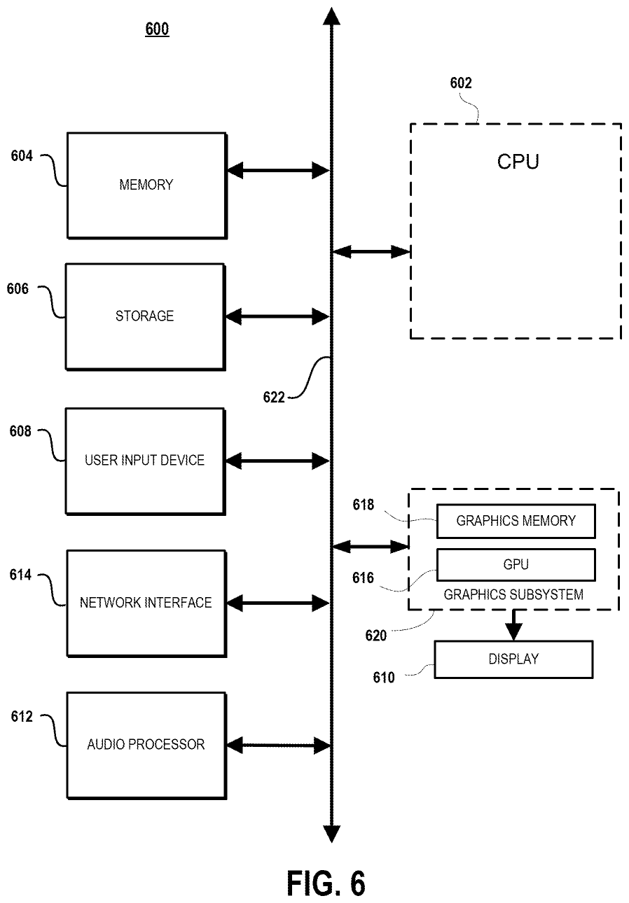

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A computer-implemented method for recommending video game gameplay to a user, comprising:
receiving a social media feed of the user;
analyzing the social media feed to determine a sentiment of the user;
using the sentiment of the user to identify a scene of a video game;
presenting a recommendation of the identified scene to the user through a user interface of a gaming platform, the recommendation configured to enable initiation of gameplay of the identified scene.

2. The computer-implemented method of claim 1, wherein analyzing the social media feed includes analyzing content of posts or reactions by the user occurring in the social media feed.

3. The computer-implemented method of claim 1, wherein determining the sentiment of the user includes identifying topics, genres, or styles of interest based on the social media feed.

4. The computer-implemented method of claim 1, wherein determining the sentiment of the user includes identifying an emotional state of the user based on the social media feed.

5. The computer-implemented method of claim 1, further comprising:
determining an initial game state for the identified scene of the video game, wherein the initial game state is applied to the identified scene of the video game when gameplay of the identified scene is initiated through the user interface.

6. The computer-implemented method of claim 5, wherein determining the initial game state includes retrieving user save data associated with the user from a prior gameplay of the video game by the user.

7. The computer-implemented method of claim 5, wherein determining the initial game state is based on the determined sentiment of the user.

8. The computer-implemented method of claim 1, further comprising:
identifying an asset used in the identified scene of the video game;
modifying the identified asset based on the determined sentiment of the user.

9. The computer-implemented method of claim 8, wherein modifying the asset includes using a generative artificial intelligence (AI) to modify an appearance of the asset.

10. The computer-implemented method of claim 9, wherein modifying the asset includes generating a prompt for the generative AI based on the determined sentiment of the user.

11. A non-transitory computer-readable medium having program instructions embodied thereon that, when executed by at least one computer, cause said at least one computer to perform a method for recommending video game gameplay to a user, said method including:
receiving a social media feed of the user;
analyzing the social media feed to determine a sentiment of the user;
using the sentiment of the user to identify a scene of a video game;
presenting a recommendation of the identified scene to the user through a user interface of a gaming platform, the recommendation configured to enable initiation of gameplay of the identified scene.

12. The non-transitory computer-readable medium of claim 11, wherein analyzing the social media feed includes analyzing content of posts or reactions by the user occurring in the social media feed.

13. The non-transitory computer-readable medium of claim 11, wherein determining the sentiment of the user includes identifying topics, genres, or styles of interest based on the social media feed.

14. The non-transitory computer-readable medium of claim 11, wherein determining the sentiment of the user includes identifying an emotional state of the user based on the social media feed.

15. The non-transitory computer-readable medium of claim 11, wherein the method further includes:
determining an initial game state for the identified scene of the video game, wherein the initial game state is applied to the identified scene of the video game when gameplay of the identified scene is initiated through the user interface.

16. The non-transitory computer-readable medium of claim 15, wherein determining the initial game state includes retrieving user save data associated with the user from a prior gameplay of the video game by the user.

17. The non-transitory computer-readable medium of claim 15, wherein determining the initial game state is based on the determined sentiment of the user.

18. The non-transitory computer-readable medium of claim 11, wherein the method further includes:
identifying an asset used in the identified scene of the video game;
modifying the identified asset based on the determined sentiment of the user.

19. The non-transitory computer-readable medium of claim 18, wherein modifying the asset includes using a generative artificial intelligence (AI) to modify an appearance of the asset.

20. The non-transitory computer-readable medium of claim 19, wherein modifying the asset includes generating a prompt for the generative AI based on the determined sentiment of the user.
